(19) United States
(12) Patent Application Publication
(10) Pub. No.: US 2023/0202703 A1
(43) Pub. Date: Jun. 29, 2023

(54) CONTAINER AND CONTAINING BODY

(71) Applicants: Masaaki ITOH, Kanagawa (JP); Rie HIRAYAMA, Kanagawa (JP); Kazuhiro FUJITA, Tokyo (JP); Shoichiro SAKAI, Kanagawa (JP)

(72) Inventors: Masaaki ITOH, Kanagawa (JP); Rie HIRAYAMA, Kanagawa (JP); Kazuhiro FUJITA, Tokyo (JP); Shoichiro SAKAI, Kanagawa (JP)

(21) Appl. No.: 18/115,774

(22) Filed: Mar. 1, 2023

Related U.S. Application Data
(63) Continuation of application No. PCT/JP2021/032372, filed on Sep. 2, 2021.

(30) Foreign Application Priority Data
Sep. 29, 2020 (JP) 2020-164091
Jun. 8, 2021 (JP) 2021-095763

(51) Int. Cl. B65D 1/40; B65D 1/02; B65D 23/08; G09F 3/02

(52) U.S. Cl. CPC B65D 1/40; B65D 1/02; B65D 23/0807; G09F 3/02; B65D 2203/02; B41M 5/267

(57) ABSTRACT

A label is attached to a base material in a container. The container includes patterns formed in a plurality of stages on the base material by laser irradiation. The patterns may include an aggregation of dots formed by the laser irradiation. The container may further include a first information region and a second information region. Information including a numeral, a symbol, or an image is made visible by the patterns in the first information region. The second information region is formed on the label. Information including a numeral, a symbol, or an image is made visible in the second information region.

### CROSS-REFERENCE TO RELATED APPLICATIONS

The present application is a continuation application of International Application No. PCT/JP2021/032372, filed Sep. 2, 2021, which claims priority to Japanese Patent Application No. 2020-164091, filed Sep. 29, 2020, and Japanese Patent Application No. 2021-095763, filed Jun. 8, 2021. The contents of these applications are incorporated herein by reference in their entirety.

### BACKGROUND OF THE INVENTION

### 1. Field of the Invention

The present invention relates to a container and a containing body.

### 2. Description of the Related Art

Japanese Unexamined Patent Application Publication No. 2011-011819 discloses a configuration of a polyethylene terephthalate (PET) bottle that is made up of a cap and a bottle without using a label by displaying description items in the form of marking and printing based on direct thermal processing or in the form of marking and printing based on molding using a mold.

### SUMMARY OF THE INVENTION

According to an aspect of the present invention, a label is attached to a base material in a container. The container includes patterns formed in a plurality of stages on the base material by laser irradiation.

### BRIEF DESCRIPTION OF THE DRAWINGS

FIG. 1 is a diagram illustrating an example of a predetermined shape according to an embodiment of the present invention;

FIG. 2A is a diagram illustrating a configuration example of a dot portion according to the present embodiment, and is a top view;

FIG. 2B is a diagram illustrating the configuration example of the dot portion according to the present embodiment, and is a cross-sectional view as viewed from an arrow C-C in FIG. 2A;

FIG. 3A is a picture of dot portions according to the present embodiment taken by a scanning electron microscope, and is a perspective view as viewed from above;

FIG. 3B is a picture of the dot portions according to the present embodiment taken by the scanning electron microscope, and is a perspective view as viewed from a cross-sectional direction of an arrow D-D in FIG. 3A;

FIG. 4 is a diagram illustrating a manufacturing apparatus according to the present embodiment;

FIG. 5 is a diagram illustrating a laser irradiation unit according to the present embodiment;

FIG. 6 is a diagram for explaining a label of a container according to the present embodiment;

FIG. 7A is a diagram for explaining a containing body according to the present embodiment;

FIG. 7B is a diagram for explaining the containing body according to the present embodiment;

FIG. 7C is a diagram for explaining the containing body according to the present embodiment;

FIG. 8A is a diagram for explaining a containing body according to a modification of the present embodiment;

FIG. 8B is a diagram for explaining the containing body according to the modification of the present embodiment;

FIG. 8C is a diagram for explaining the containing body according to the modification of the present embodiment;

FIG. 9A is a diagram for explaining a containing body according to a second modification of the present embodiment;

FIG. 9B is a diagram for explaining the containing body according to the second modification of the present embodiment;

FIG. 9C is a diagram for explaining the containing body according to the second modification of the present embodiment;

FIG. 10A is a diagram for explaining a containing body according to a third modification of the present embodiment;

FIG. 10B is a diagram for explaining the containing body according to the third modification of the present embodiment;

FIG. 10C is a diagram for explaining the containing body according to the third modification of the present embodiment;

FIG. 11A is a diagram for explaining a containing body according to a fourth modification of the present embodiment;

FIG. 11B is a diagram for explaining the containing body according to the fourth modification of the present embodiment;

FIG. 11C is a diagram for explaining the containing body according to the fourth modification of the present embodiment;

FIG. 12 is a diagram for explaining patterns in the containing body according to the present embodiment;

FIG. 13A is a diagram for explaining the patterns according to the present embodiment;

FIG. 13B is a diagram for explaining the patterns according to the present embodiment;

FIG. 13C is a diagram for explaining the patterns according to the present embodiment; and

FIG. 13D is a diagram for explaining the patterns according to the present embodiment.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment has an object provide a container that takes advantage of both of a label and a pattern.

Modes for carrying out the present invention will be described below with reference to the drawings. In each of the drawings, the same components are denoted by the same reference symbols, and repeated explanation may be omitted. In addition, the embodiments described below illustrate an apparatus that implements the technical idea of the present invention, and the present invention is not limited to the embodiments described below. Dimensions, materials, shapes, relative positions, and the like of the components described below are illustrated by way of example and not intended to limit the scope of the present invention unless otherwise specified. Furthermore, sizes, positional relationships, and the like of members illustrated in the drawings may be exaggerated for the sake of clarity of description.

A base material according to one embodiment of the present invention is a base material in which a predetermined shape that constitutes a pattern is formed in at least a partial region. The base material means a material portion of an object. Examples of the object include a container. Examples of the container include a polyethylene terephthalate (PET) bottle that is made of a material including resin, such as PET, and that contains a beverage. However, the object is not specifically limited, and any object may be applicable. A shape and a material of the container are not specifically limited, and the container may have any shape and may be made of any material.

“At least the partial region” of the base material includes a region on a surface of the base material. The surface of the base material means a surface of the material that is exposed to outside air. In the embodiments, a phrase of “the surface of the base material” is used as a relative phrase of an internal portion of the base material; therefore, for example, in the case of a plate-shaped base material, both of a front surface and a back surface of the base material correspond to the surface of the base material. Further, in the case of a tubular base material, both of an outer surface and an inner surface of the base material correspond to the surface of the base material.

The pattern includes a letter, a code, such as a barcode, a graphic, an image, and the like, and displays information, such as a name, an identification number, a manufacturer, and a manufacturing date and time, on the container or contents, such as a beverage, that is contained in the container, for example.

In the case of the container, such as a PET bottle, the above-described information may be displayed by attaching a recording medium on which the above-described information is recorded onto the surface of the container; however, in the embodiments, by forming a pattern representing the above-described information on the surface of the base material that constitutes the container, the above-described information is displayed without using the recording medium.

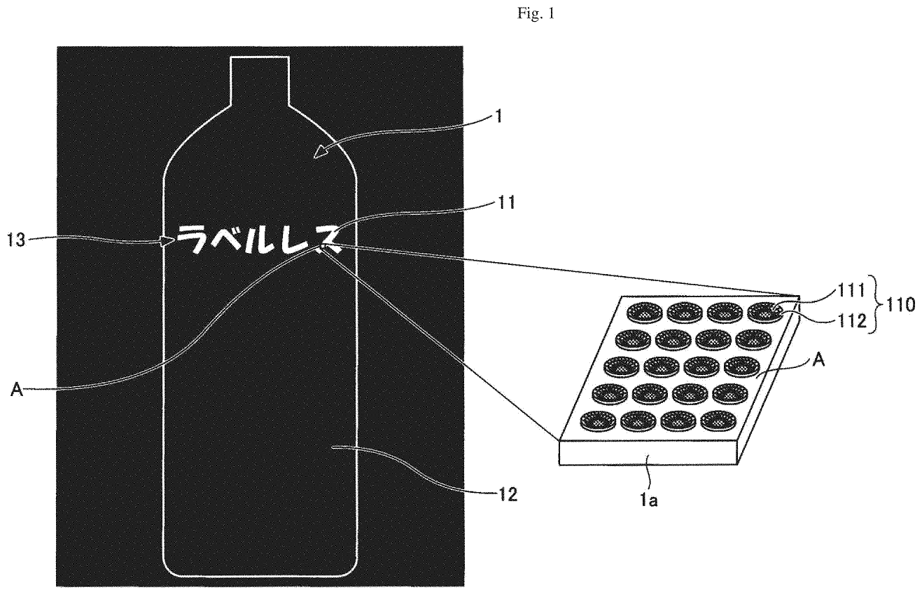

FIG. 1 is a diagram for explaining an example of a predetermined shape that is formed on a base material according to the present embodiment. FIG. 1 illustrates a part of a base material 1a that constitutes a container 1 with a surface on which a pattern 11 is formed. The container 1 and contents constitute a containing body. The container 1 is configured with, as one example, the base material 1a that is made of PET resin having transparency to visible light. Meanwhile, the visible light is light having wavelengths in the range of about 360 nanometers (nm) to about 400 nm in a short-wavelength band and having wavelengths in the range of about 760 nm to about 1600 nm in a long-wavelength band.

The pattern 11 includes a character string of “labellers” in katakana. A region A is a partial region of a letter “s” in katakana in the pattern 11. A perspective view B is an enlarged schematic view of the region A for explaining details of the configuration of the pattern 11.

As illustrated in the perspective view B, the region A includes a plurality of dot portions 110. The dot portions 110 are formed in at least a partial region of the base material, and are illustrated as one example of predetermined shapes that constitute the pattern. Meanwhile, the predetermined shape includes a shape that is formed on the surface of the base material, and an inner shape, such as an air space portion, that is present under the shape formed on the surface of the base material.

Each of the dot portions 110 is, as one visual example, a slightly opaque portion and includes a recess 111 and a protrusion 112. The recess 111 is a portion that is recessed from the surface of the base material 1a that constitutes the container 1, and is one example of a predetermined recess. The protrusion 112 is a portion that protrudes from the surface of the base material 1a that constitutes the container 1, and is one example of a predetermined protrusion. The protrusion 112 is formed around the recess 111 so as to enclose the recess 111.

The plurality of dot portions 110 are formed as an aggregation on the base material 1a that constitutes the container 1, and forms the character string of “labellers” in the pattern 11. Here, the aggregation indicates what is formed by aggregating individual entities, and the pattern 11 is formed of an aggregation of the plurality of dot portions 110.

In the base material 1a, a pattern region 13 in which the pattern 11 including the plurality of dot portions 110 is formed corresponds to a first region. Further, a non-pattern region 12 other than the first region in the base material 1a corresponds to a second region.

In the pattern region 13, because the plurality of dot portions 110 are formed, a reflection direction and optical diffusion of light that enters the container 1 are different from those in the non-pattern region 12. Therefore, at least one of optical transmittance and optical reflectance of light that enters the container 1 is different between the pattern region 13 and the non-pattern region 12. Due to the difference in at least one of the optical transmittance and the optical reflectance, a person who views the container 1 is able to view the pattern 11 formed on the container 1.

Further, an entire width (dot width) of each of the dot portions 110 and an interval (dot interval) between the dot portions 110 are small relative to the pattern 11. Therefore, a person who views the container 1 is able to view the letter of “labellers” in the pattern 11 without visually recognizing the dot portions 110.

An inter-dot gap that can prevent the dot portions 110 from being visually recognized varies depending on a visual acuity of a person who views the container 1, a distance between eyes and the container 1, or the like, but it is preferable to set the gap to 100 micrometers (μm) or less. Further, although it is ideal to reduce the dot width as much as possible, a preferable dot width is about 100 um or less as a preferable size with which the shapes of the dot portions are not distinguishable. This will be described in detail below.

If a person with 6/4 vision views the container 1 at a distance of about 30 centimeters (cm), the person is generally able to recognize a black-and-white point (dot) with a size of 50 μm. This limit value increases with a decrease in contrast between black and white, but is generally about 50 μm. However, a dot with a size of 30 μm may be viewed if only the dot is present, and in some cases, a dot with a size of 10 μm may be viewed if the dot has high contrast.

Furthermore, if the two dot portions 110 are present in an adjacent manner, whether the two dot portions 110 can be viewed depends on resolution of the human eye or the like. Meanwhile, the resolution is a minimum distance at which two points can be recognized as two separate points.

The resolution of the human eye is generally 100 μm at a distance of 30 cm, although it depends on a visual acuity. 30 cm corresponds to a distance at which the person views information, such as a label, displayed on a PET bottle when the person picks up the PET bottle containing drinking water or the like in his/her hand. In other words, if the person picks up the PET bottle while slightly flexing an elbow, an interval between the eyes of the person and the PET bottle is about 30 cm. The distance varies in a range from 30 cm to 50 cm by taking into account a physical size of the person. The resolution is about 100 μm at the distance of 30 cm, and about 160 μm at the distance of 50 cm.

Further, as another index, when 200 dots per inch (dpi) is ensured as a boundary of the resolution, and if the gap between the adjacent dots is 130 μm or less, the dots are viewed as a unity, instead of being viewed separately from one another.

As described above, by preferably setting the gap between the dots to 160 μm or less, or more preferably setting the gap to 100 μm or less, the dot portions 110 are viewed as a continuous body instead of being viewed as separate dots, so that it is possible to view a pattern, such as the letter of “labellers”, in the pattern 11. Furthermore, if the size of the dot is larger than 100 μm, shape changes of the dots may be visually recognized. Therefore, by preferably setting the dot size to 160 μm or less, or more preferably setting the dot size to 100 μm or less, even if the shapes of the dots are changed, it is possible to perceive the dots as a uniform pattern, so that it is possible to view a pattern, such as a letter, that is an aggregation of the dots as a uniform pattern without graininess.

To form the dot portions 110, various machining methods, such as laser machining, electric spark machining, etching, cutting machining, or a molding machining using a mold, may be applied. Among the machining methods as described above, the laser machining method is preferable because it is possible to machine the base material in a non-contact manner, and it is possible to perform machining at a high speed by using laser light scanning, a light source array, pattern exposure, or the like.

In the laser machining, it is possible to change the sizes, the shapes, the depths, or the like of the dot portions 110 by adjusting optical energy of laser light (laser beam) to be emitted, a size of the laser beam, or an irradiation time, for example. Further, a cross-sectional strength distribution of the laser beam is generally a Gaussian distribution, but it is possible to generate a strength distribution in a top hat form in which a center of the strength distribution is flat, by adjusting the strength distribution by a combination of laser beams from an array light source or by designing an irradiation optical system.

The recess 111 in each of the dot portions 110 is formed by melting, burning, vaporizing, or deforming a part of the base material 1a at a laser light irradiation position. The protrusion 112 is formed such that a part of the base material 1a that is broken up from the recess 111 adheres to and is solidified in the vicinity of the recess 111 without being burned out or vaporized. This processing mainly uses thermal energy, and therefore, it is preferable to adopt resin or the like with relatively low thermal conductivity as a material of the base material la; however, the processing may be applied to other materials, such as glass.

Furthermore, by controlling thermal conductivity, it is possible to form various predetermined shapes, such as the dot portions 110. To control thermal conductivity, for example, it may be possible to adopt a material with high thermal conductivity as the base material 1a, or it may be possible to firmly attach a different material with high thermal conductivity to the base material 1a in order to rapidly transfer heat that is generated by the base material 1a due to irradiation with the laser light. Examples of the different material with high thermal conductivity include a cooling liquid and a metal.

Moreover, a phenomenon, such as melting, evaporation, crystallization, or foaming, in the laser machining irregularly occurs in an irradiation region, so that a surface of the pattern region 13 may get rough, and surface roughness of the pattern region 13 is likely to increase relative to the non-pattern region 12. With an increase in the surface roughness, in the pattern region 13, the optical diffusion with respect to light that enters the container 1 is increased relative to the non-pattern region 12. As a result, the contrast of the pattern 11 is increased and visibility of the pattern 11 is further increased. In this point, the laser machining is more preferable.

Furthermore, in the present embodiment, the pattern is formed of the aggregation of the plurality of dot portions 110 each including at least one of the recess 111 and the protrusion 112, so that a surface area is increased along the shapes of the recesses 111 and the protrusions 112 and a region with large surface roughness is further increased as compared to a pattern that is formed of a bundle of grooves and hollows. Moreover, the pattern is formed of the aggregation of the plurality of dot portions 110, so that the surface area is further increased along the shapes of the plurality of dot portions 110. Accordingly, the optical diffusion is further increased, so that the contrast is increased and the visibility is further improved.

Meanwhile, in the example illustrated in the perspective view B, the dot portions 110 are formed by being regularly arranged in a square-lattice shape, but embodiments are not limited to this example. The dot portions may be formed by being arranged in a triangular-lattice shape or a honeycomb shape, or may be formed irregularly such that arrangement intervals are different from one another instead of being regularly arranged.

Furthermore, while the pattern 11 including the character string of “labellers” is illustrated, embodiments are not limited to this example. The pattern 11 may include an arbitrary character string, a graphic, a photograph, a symbol, a code, such as a barcode or a QR code, or a combination of the character string, the graphic, the photograph, the symbol, and the code. In other words, the pattern 11 is an image, and the image is formed by the predetermined shapes, such as the dot portions 110.

Configuration Example of Dot Portion 110

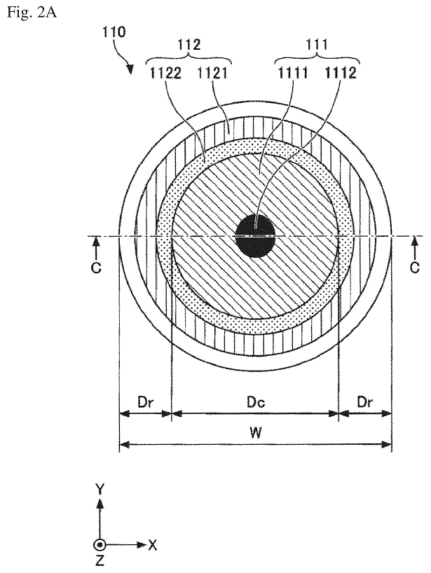

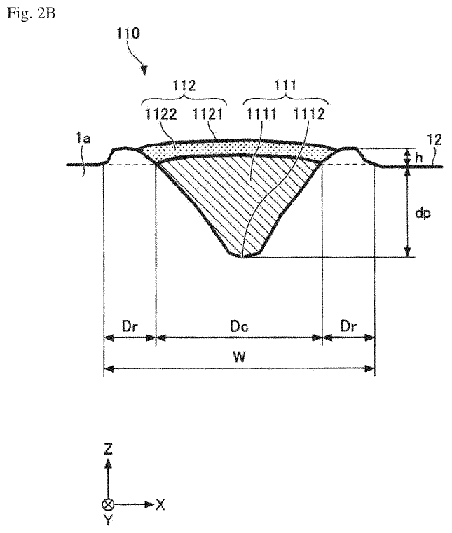

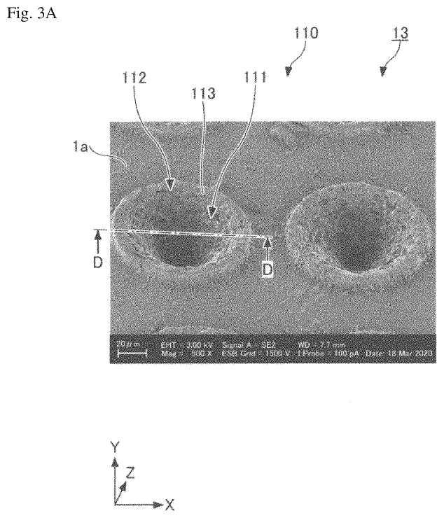

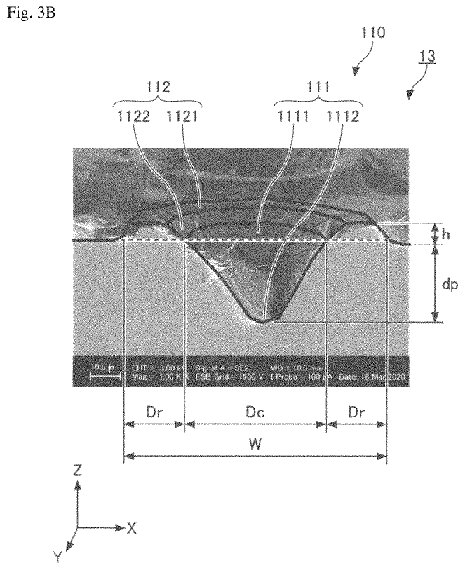

FIGS. 2A and 2B are diagrams for explaining an example of a configuration of the dot portion 110 according to the present embodiment, where FIG. 2A is a top view, and FIG. 2B is a cross-sectional view as viewed from an arrow C-C in FIG. 2A. FIGS. 3A and 3B are pictures of the dot portions 110 according to the present embodiment taken by a scanning electron microscope (SEM), where FIG. 3A is a perspective view as viewed from above, and FIG. 3B is a perspective view as viewed from a cross-sectional direction of an arrow D-D in FIG. 3A. FIGS. 3A and 3B illustrate an SEM picture in which a part of the pattern region 13 is observed in an enlarged manner. In FIG. 3A, two of the dot portions 110 are entirely observed, parts of other two of the dot portions 110 are slightly observed in the positive Y-axis direction, and parts of other two of the dot portions 110 are slightly observed in the negative Y-axis direction. Furthermore, the dot width is set to about 100 um.

As illustrated in FIGS. 2A to. 3B, each of the dot portions 110 includes the recess 111 and the protrusion 112. The recess 111 includes a first inclined surface 1111 (diagonal line hatching portion) and a bottom portion 1112 (black portion), and is formed in a cup shape. A recess width Dc represents a width of the recess 111, and a depth dp represents a height of the bottom portion 1112 with respect to the surface of the non-pattern region 12 (length in the Z-axis direction).

Further, the protrusion 112 includes an apex portion 1121 (vertical line hatching portion) and a second inclined surface 1122 (pear-skin hatching portion), and is formed in a torus shape. Meanwhile, the torus shape is a surface of revolution generated by revolving a circle. A torus width Dr represents a width of a torus portion of the protrusion 112 in a radial direction, and a height h represents a height of the apex portion 1121 with respect to the surface of the non-pattern region 12 (length in the Z-axis direction).

The dot width W represents an entire width of the dot portion 110. The first inclined surface 1111 and the second inclined surface 1122 are continuous surfaces. The continuous surfaces indicate surfaces that are made of the same material and continued without any stepped portion.

Furthermore, as illustrated in FIGS. 3A and 3B, a micro asperity portion 113 is formed on a surface of each of the recess 111 and the protrusion 112, and the surface gets rough. The asperity portion 113 is one example of an asperity portion including a recess and a protrusion that are smaller than the predetermined shape. The asperity portion 113 includes a recess and a protrusion with widths that are smaller than the dot width W of the dot portion 110, and typically includes a recess and a protrusion with widths of about 1 μm to 10 μm.

Moreover, as illustrated in FIG. 3A, machining chips that are generated at the time of machining the dot portions 110 are scattered in each of regions between the dot portions 110, and surfaces get rough due to the machining chips. In the pattern region 13, the surfaces get rough due to the asperity portion 113 and the machining chips, so that the surface roughness is increased as compared to the non-pattern region.

The dot portions 110 can be formed by, for example, irradiating the base material 1a with laser light and denaturalizing the surface of the base material 1a. The single dot portion 110 is formed by collecting laser light onto a single point on the base material 1a. Furthermore, the plurality of dot portions 110 are formed by performing two-dimensional scanning using the laser light. Alternatively, the plurality of dot portions may be formed by a plurality of pieces of laser light emitted from a plurality of laser light sources that are arranged as an array. Moreover, it may be possible to form the plurality of dot portions 110 in a parallel manner by single exposure by irradiating a mask member, which has a plurality of light transmission openings corresponding to positions of the respective dot portions 110, with expanded laser light, and applying a group of a plurality of pieces of transmitted laser light that have transmitted through the light transmission openings of the mask member.

As a laser light source that emits laser light, various laser light sources are applicable. It is preferable to use a laser light source capable of performing pulsed oscillation at picosecond to nanosecond time scales. Examples of a solid-state laser include YAG lasers and titanium-sapphire lasers. Examples of a gas laser include argon lasers, helium neon lasers, and carbon dioxide lasers. A semiconductor laser is also preferable because it is small. Furthermore, a fiber laser which is one kind of solid-state lasers and in which an optical fiber is used as an amplifying medium is a most optimal light source in terms of having high peak energy and having a potential to be reduced in size.

Configuration Example of Manufacturing Apparatus 100

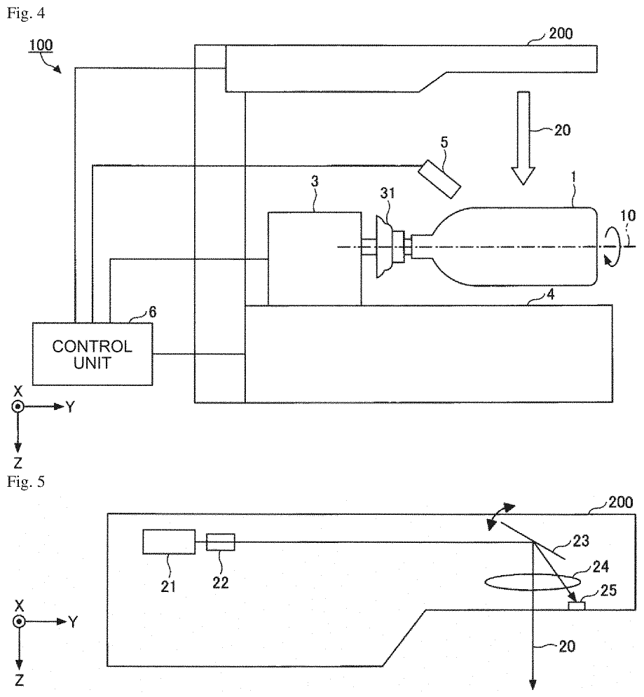

FIG. 4 is a diagram illustrating an example of a configuration of a manufacturing apparatus 100. The manufacturing apparatus 100 is an apparatus that changes a property of the base material of the container 1 to form a pattern that is formed of an aggregation of predetermined shapes on the surface of the base material. In other words, the manufacturing apparatus 100 is one example of a pattern formation apparatus. Here, the property of the base material indicates a nature or a state of the base material.

As illustrated in FIG. 4, the manufacturing apparatus 100 includes a laser irradiation unit 200, a rotation mechanism 3 that rotates the container 1 that is a machining target object, a holding unit 31, a moving mechanism 4, a dust collection unit 5, and a control unit 6. The manufacturing apparatus 100 holds the container 1, which is a cylindrical container, such that the container 1 can rotate about a cylindrical axis 10 of the container 1 via the holding unit 31. Further, the laser irradiation unit 200 irradiates the container 1 with laser light to change the property of the base material of the container 1, so that a pattern is formed on the surface of the container 1.

The laser irradiation unit 200 performs scanning, in a Y direction in FIG. 4, with laser light emitted from a laser light source, and emits a machining laser beam 20 toward the container 1 that is arranged in the positive Z-axis direction. Meanwhile, the laser irradiation unit 200 will be described in detail later with reference to FIG. 5.

The rotation mechanism 3 holds the container 1 via the holding unit 31. The holding unit 31 is a coupling member that is connected to a motor shaft of a motor (not illustrated) that serves as a driving unit and that is included in the rotation mechanism 3, and holds the container 1 in such a manner that one end of the holding unit 31 is inserted into an opening portion of the container 1. By rotating the holding unit 31 with rotation of the motor shaft, the container 1 held by the holding unit 31 is rotated about the cylindrical axis 10.

The moving mechanism 4 is a direct-acting stage including a table, and the rotation mechanism 3 is placed on the table of the moving mechanism 4. The moving mechanism 4 moves the table back and forth in the Y direction, and integrally moves the rotation mechanism 3, the holding unit 31, and the container 1 back and forth.

The dust collection unit 5 is an air suction device that is arranged in the vicinity of a portion of the container 1 to be irradiated with the machining laser beam 20. By collecting, by means of air suction, plume and dust that are generated when a first pattern is formed by irradiation with the machining laser beam 20, the manufacturing apparatus 100, the container 1, and the vicinities of the manufacturing apparatus 100 and the container 1 are prevented from being tainted by the plume and the dust.

The control unit 6 is electrically connected to each of a laser light source 21, a scanning unit 23, the rotation mechanism 3, the moving mechanism 4, and the dust collection unit 5 by a cable or the like, and controls operation of each of the units by outputting a control signal.

The manufacturing apparatus 100 causes the laser irradiation unit 200 to irradiate the container 1 with the machining laser beam 20 by scanning in the Y-axis direction, while causing the rotation mechanism 3 to rotate the container 1 under the control of the control unit 6. Then, a two-dimensional pattern is formed on the surface of the base material of the container 1.

Here, a range of a scanning area to be scanned with the machining laser beam 20 in the Y-axis direction by the laser irradiation unit 200 may be limited. Therefore, if a pattern is to be formed in a wider range than the scanning area, the manufacturing apparatus 100 causes the moving mechanism 4 to move the container 1 in the Y-axis direction to shift an irradiation position of the machining laser beam 20 on the container 1 in the Y direction. Thereafter, by causing the laser irradiation unit 200 to perform scanning with the machining laser beam 20 in the Y-axis direction while causing the rotation mechanism 3 to rotate the container 1 again, the pattern is formed on the surface of the base material of the container 1. With this configuration, it is possible to form a pattern in a wide area of the container 1 (an arbitrary area from the opening portion of the bottle to a bottom surface of the bottle).

Configuration Example of Laser Irradiation Unit 200

FIG. 5 is a diagram illustrating an example of a configuration of the laser irradiation unit 200. As illustrated in FIG. 5, the laser irradiation unit 200 includes the laser light source 21, a beam expander 22, the scanning unit 23, a scanning lens 24, and a synchronous detection unit 25.

The laser light source 21 is, for example, a pulsed laser that emits laser light. The laser light source 21 emits laser light with certain output power (optical intensity) that is preferable to change the property of the surface of the base material of the container 1 irradiated with the laser light.

The laser light source 21 is able to control ON and OFF of laser light emission, an emission frequency, optical intensity, and the like. As one example of the laser light source 21, a laser light source for which a wavelength is 532 nm, a pulse width of laser light is 16 picoseconds, and average output power is 4.9 watts (W) may be used. It is preferable to set a diameter of the laser light in an area in which the property of the base material is to be changed in the container 1 to equal to or larger than 1 μm and equal to or smaller than 200 μm.

Furthermore, the laser light source 21 may include a single laser light source or a plurality of laser light sources. If a plurality of laser light sources are used, ON and OFF, emission frequencies, optical intensities, and the like of the laser light sources may be controlled in an independent manner or in a common manner.

A diameter of the laser light of parallel light emitted from the laser light source 21 is expanded by the beam expander 22, and the laser light enters the scanning unit 23.

The scanning unit 23 includes a scanning mirror that changes a reflection angle by the driving unit, such as the motor. By changing the reflection angle by the scanning mirror, scanning with the incident laser light is performed in the Y-axis direction. As the scanning mirror, a Galvanomirror, a polygon mirror, a micro electro mechanical system (MEMS) mirror, or the like may be used.

Meanwhile, in the embodiment, an example in which the scanning unit 23 performs scanning with the laser light in the Y-axis direction is illustrated, but embodiments are not limited to this example. The scanning unit 23 may perform two-dimensional scanning with the laser light in the XY directions by using a scanning mirror that changes the reflection angle in two directions perpendicular to each other.

However, when the surface of the cylindrical container 1 is irradiated with laser light, and if two-dimensional scanning in the X-axis direction and the Y-axis direction is performed, a beam spot diameter on the surface of the container 1 is changed in accordance with scanning in the X-axis direction, and therefore, in this case, it is preferable to perform one-dimensional scanning.

The laser light used for scanning by the scanning unit 23 is applied, as the machining laser beam 20, to the surface of the base material of the container 1.

The scanning lens 24 is an fθ lens that maintains a constant scanning speed of the machining laser beam 20 used for scanning by the scanning unit 23, and causes the machining laser beam 20 to converge at a predetermined position on the surface of the base material of the container 1. It is preferable to arrange the scanning lens 24 and the container 1 such that the beam spot diameter of the machining laser beam 20 is minimized in the area in which the property of the base material of the container 1 is to be changed. Meanwhile, the scanning lens 24 may be formed of a combination of a plurality of lenses.

The synchronous detection unit 25 outputs a synchronous detection signal that is used to synchronize the scanning using the machining laser beam 20 and the rotation of the container 1 performed by the rotation mechanism 3. The synchronous detection unit 25 includes a photodiode that outputs an electrical signal corresponding to optical intensity of received light, and outputs the electrical signal of the photodiode as the synchronous detection signal to the control unit 6.

While FIG. 5 illustrates the example in which the machining laser beam is used for scanning, it may be possible to form a machining laser beam array by arranging a large number of machining laser beams in a range of a printing width, and scan the container 1 in a single direction with the large number of laser beams by rotating the container 1, for example.

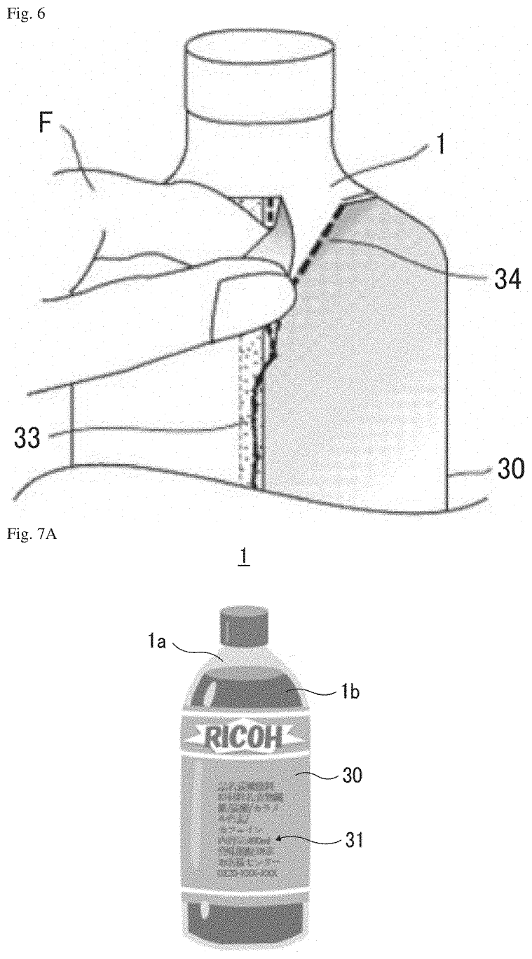

FIG. 6 is a diagram for explaining a label of the container according to the present embodiment. FIG. 6 illustrates the container 1 to which a label 30 is attached, where the label 30 includes a seal portion 33 and a perforation 34, and can be removed from the container 1 with a finger F.

A molded PET bottle has a three-dimensional shape, and it is difficult to directly perform printing on a bottle surface; therefore, a label has been used for display.

The label includes a “shrink label” that is made of a polystyrene material or a polyester material and firmly attached to a bottle by application of heat, a “roll label” that is made of a slit film and attached with glue by a labeller, and the like. Labels have certain advantages and disadvantages such that, for example, the roll label is simple and economical, but does not fit to a container having a narrow part; therefore, an appropriate label is selected in accordance with a container shape that depends on a beverage to be contained.

To recycle the material of the PET bottle, it is necessary to eliminate a cap and a label that are made of different materials, and therefore, the label is designed such that the label can easily be removed at the time of recovery; for example, a perforation is arranged in the shrink label that is of a type to be firmly attached along an outline of a bottle by thermal shrinkage, and a “peel assist portion” as a portion to which an adhesive is not applied is arranged in the roll label that is of a type in which a rolled label is fixed with an adhesive.

The label is generally printed by a printing company called a converter. In recent years, a printing method in which printing plates are not used by performing printing using an inkjet printer or the like and printing information is changeable for each sheet of paper is applicable; however, economic efficiency of the above-described method is extremely low, and the method is usually used only for a special sales campaign or products that are produced in small quantities. If priority is given to the economic efficiency, printing plates are generated and printing in large quantities is performed by offset printing or gravure printing.

The label to be printed is usually designed by a beverage manufacturer or a company outsourced by the beverage manufacturer, but the printing plates are generated by a printing company. To reproduce a received design document by gravure printing or offset printing, operation of performing processing and making separate plates is performed; however, for example, in the case of the shrink label, conversion operation is not simple because of thermal shrinkage. Some bottles include thick portions or thin portions, and a shrinkage ratio at the time of shrinking varies depending on the shapes, so that the way of shrinking of the display varies between the thick portions and the thin portions. The shrinkage ratio can be roughly estimated by calculation. Proofing of the plates is usually performed by outputting the plates to films by a color printer, and after the proofing, printing is performed by a dedicated proof press using shrink films for mass production, an actual bottle shape is formed by applying heat, color reproduction and a shrunk design are checked, and final printing plates are completed. In this manner, a plurality of companies perform a plurality of processes until completion of the printing plates, and operation needs efforts, costs, and times.

The label displays a design or an image that appeals to consumers, a product name, and a manufacturer name as graphics to exhibit originality of a product, improve awareness of the product, and improve competitiveness of the product; various kinds of information, such as ingredients and energy of contents, a best-before date, the product name, a place of production, a seller, contact information, uptake efficiency, and cautions, that are provided in view of consumer protection, environment conservation, and social responsibility based on laws, ministerial ordinances, and guidelines provided by industry organizations and manufacturers; and various kinds of information, such as a barcode and a quick response (QR) code (registered trademark) for distribution, a recycle mark, and a material mark of a package container.

Even when the product itself is not changed, if any of laws, ministerial ordinances, and guidelines provided by industry organizations and manufacturers is changed, if the product is improved, or if raw materials are changed, it is necessary to change the information written on the label and change the printing plates for the label, so that efforts, costs, and times are needed to change the plates. Furthermore, it is necessary to combine a label that is manufactured by the changed plates when the changed law, the changed ministerial ordinance, or the changed guideline is applied or when the product is changed, so that efforts and costs are needed for production management.

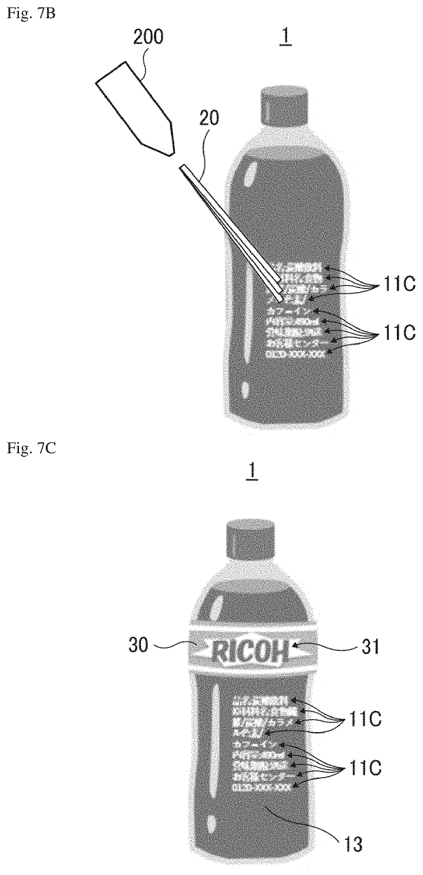

FIGS. 7A to 7C are diagrams for explaining the containing body according to the present embodiment. FIG. 7A illustrates a containing body according to a comparative example, where the containing body includes the container 1, in which the label 30 is attached to the base material 1a, and contents 1b. A label printing region 31 is formed on the label 30.

FIG. 7B illustrates the containing body according to the present embodiment before the label 30 is attached, where the containing body includes the container 1 and the contents 1b. A plurality of letters 11C are formed in a plurality of stages on the base material 1a of the container 1. The letters 11C are one example of the patterns 11 in the plurality of stages that are formed with the machining laser beam 20 emitted by the laser irradiation unit 200.

FIG. 7C illustrates the containing body according to the present embodiment after the label 30 is attached, where the containing body includes the container 1, in which the label 30 is attached to the base material 1a, and the contents 1b.

The base material 1a of the container 1 includes the pattern region 13 including the letters 11C that are formed in the plurality of stages, and the label printing region 31 is formed on the label 30.

The pattern region 13 is one example of a first information region in which information, such as a numeral, a symbol, or an image, is made visible by the patterns 11, and the label printing region 31 is one example of a second information region which is formed on the label 30 and in which information, such as a numeral, a symbol, or an image, is made visible.

Conventionally, as illustrated in FIG. 7A, by printing almost all pieces of needed information on the label and attaching the label to the container, information display as a product as needed by a manufacturer, a sales company, and a society is performed.

In contrast, in the present embodiment, as illustrated in FIG. 7B and FIG. 7C, information that is displayed by relatively small characters or the like, other than the graphics that are written to exhibit originality of a product, improve awareness of the product, and improve competitiveness of the product and other than the product names and the manufacturer names that are displayed in relatively large characters, are directly marked on the container by using laser.

With this configuration, it is possible to reduce information to be written on the label, so that it is possible to reduce an area needed for the label. Consequently, it is possible to reduce operational burden and time needed to remove the label at the time of recovery for material recycle.

In addition, in recent years, marine pollution due to plastic debris is becoming a controversial issue, and actions to reduce plastic pollution are vigorously taken worldwide: in view of this, it is possible to reduce environmental burden by reducing the area needed for the label.

Furthermore, in the present embodiment, information including display information that may be changed even when the product itself is not changed is directly marked onto the container by using laser, and a design and an image that appeals to consumers, a product name, and a manufacturer name are mainly displayed, as relatively large characters, on the label.

With this configuration, it is possible to maintain the effect of the label to exhibit originality of the product, improve awareness of the product, and improve competitiveness of the product, and it becomes not necessary to change the printing plates for the label even if any of laws, ministerial ordinances, and guidelines provided by industry organizations or manufacturers is changed, even if the product is improved, or even if raw materials are changed.

Furthermore, it is not necessary to combine a label that is manufactured by the changed plates when the changed law, the changed ministerial ordinance, or the changed guideline is applied or when the product is changed, so that efforts and costs are not needed for production management.

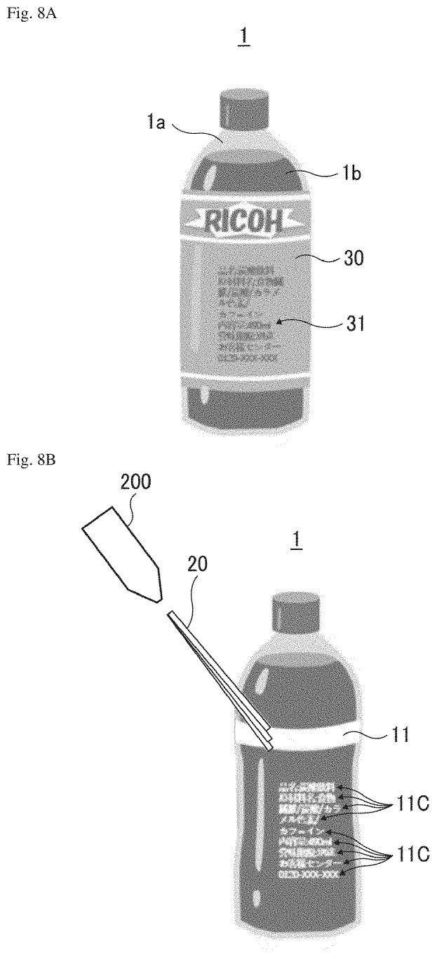

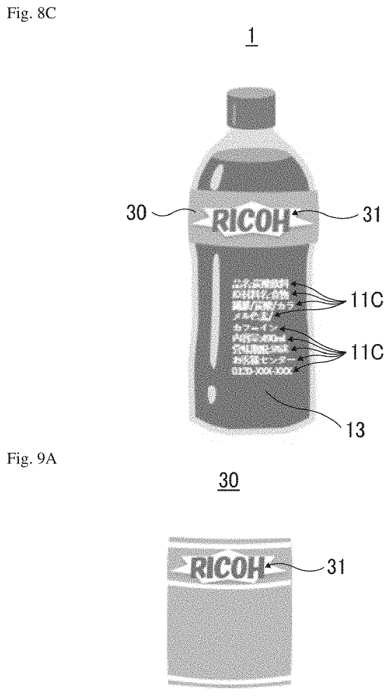

FIGS. 8A to 8C are diagrams for explaining a containing body according to a modification of the present embodiment. FIG. 8A illustrates a containing body according to a comparative example, which has the same configuration as illustrated in FIG. 7A.

FIG. 8B illustrates the containing body according to the present modification before the label 30 is attached, where the containing body includes the container 1 and the contents 1b. The plurality of letters 11C are formed in a plurality of stages on the base material 1a of the container 1. The letters 11C are one example of the patterns 11 in the plurality of stages that are formed with the machining laser beam 20 emitted by the laser irradiation unit 200. The pattern 11 other than the letters 11C is also formed on the base material 1a of the container 1 illustrated in FIG. 8B.

FIG. 8C illustrates the containing body according to the present modification after the label 30 is attached, where the containing body includes the container 1, in which the label 30 is attached to the base material 1a, and the contents 1b.

The base material 1a of the container 1 includes the pattern region 13 including the letters 11C that are formed in the plurality of stages, and the label printing region 31 is formed on the label 30. The label 30 is attached to a position at which the pattern 11 is formed.

If an area of the label is small, an area in which the label comes into contact with the container is reduced, and a frictional force generated between the label and the container is reduced; therefore, production quality at the time of attaching the label in a production process and label stability at the time of distribution and handling by a user are reduced.

To compensate for this, it is necessary to tighten production management. In other words, production management items including accuracy of materials and dimensions of label components and environments in a container production process and a label attaching process needs to be tightened; however, this needs efforts and costs for production.

If direct marking onto the container is performed using laser, for example, the marked portion on a transparent PET container becomes opaque, and this occurs because the surface of the PET container is deformed into a recessed shape due to abrasion caused by laser energy and light is scattered.

By performing marking at a position at which the label is attached, it is possible to increase surface roughness of the container and increase a frictional force with a label film. In other words, by attaching the label 30 at the position at which the pattern 11 is formed, it is possible to improve the frictional force due to the pattern 11, so that attachment performance of the label 30 is improved.

With this configuration, the stability of the label attached to the container is ensured, so that even for a small label, it is possible to ensure quality without a need of efforts and costs for production.

Meanwhile, the pattern 11 formed at the position at which the label 30 is attached may be a continuous pattern or an intermittent pattern in a circumferential direction of the container 1. Further, the pattern 11 may be formed in an entire area or a partial area in a height direction of the container 1. Furthermore, the pattern 11 need not always be a regular pattern, but may be letters or characters.

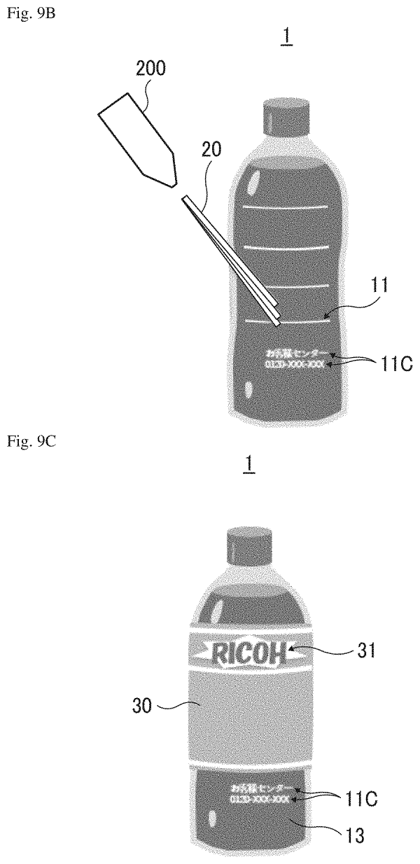

FIGS. 9A to 9C are diagrams for explaining a containing body according to a second modification of the present embodiment. FIG. 9A illustrates the label 30 according to the present modification, where the label 30 includes a window portion 32 in which the patterns 11 formed at the position at which the label 30 is attached are viewable.

FIG. 9B illustrates the containing body according to the present modification before the label 30 is attached, where the containing body includes the container 1 and the contents 1b. The letters 11C are formed in a plurality of stages on the base material 1a of the container 1. The letters 11C are one example of the patterns 11 in the plurality of stages that are formed with the machining laser beam 20 emitted by the laser irradiation unit 200. The patterns 11 other than the letters 11C are also formed in the plurality of stages on the base material 1a of the container 1 illustrated in FIG. 9B.

FIG. 9C illustrates the containing body according to the present modification after the label 30 is attached, where the containing body includes the container 1, in which the label 30 is attached to the base material 1a, and the contents 1b.

The base material 1a of the container 1 includes the pattern region 13 including the letters 11C that are formed in the plurality of stages, and the label printing region 31 is formed on the label 30. The label 30 is attached to a position at which the patterns 11 are formed in the plurality of stages. In this case, the frictional force is increased by the patterns 11 in the plurality of stages, so that the attachment performance of the label 30 is improved.

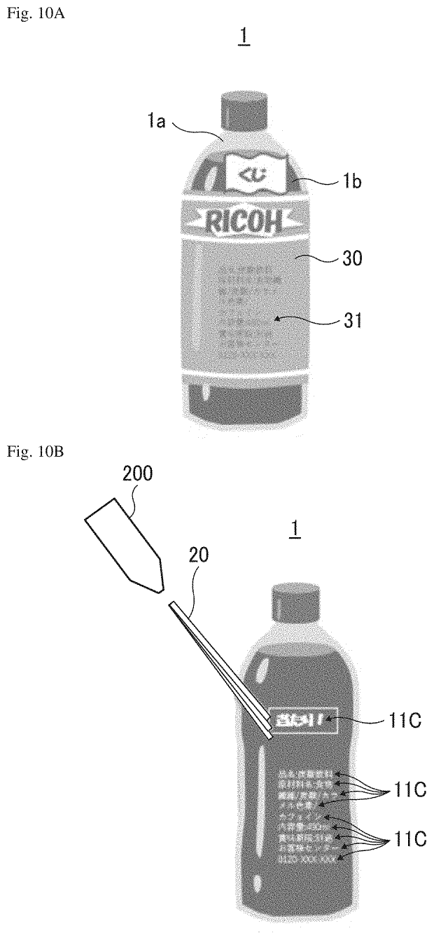

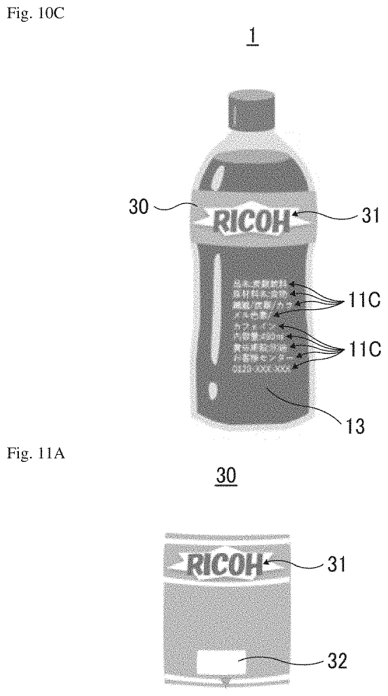

FIGS. 10A to 10C are diagrams for explaining a containing body according to a third modification of the present embodiment. FIG. 10A illustrates a containing body according to a comparative example, which has the same configuration as illustrated in FIG. 7A.

FIG. 10B illustrates the containing body according to the present modification before the label 30 is attached, where the containing body includes the container 1 and the contents 1b. The letters 11C are formed in a plurality of stages on the base material 1a of the container 1. The letters 11C are one example of the patterns 11 in the plurality of stages that are formed with the machining laser beam 20 emitted by the laser irradiation unit 200. The letters 11C are formed also at the position at the label 30 is attached on the base material 1a of the container 1 illustrated in FIG. 10B.

FIG. 10C illustrates the containing body according to the present modification after the label 30 is attached, where the containing body includes the container 1, in which the label 30 is attached to the base material 1a, and the contents 1b.

The base material 1a of the container 1 includes the pattern region 13 including the letters 11C that are formed in the plurality of stages, and the label printing region 31 is formed on the label 30. The label 30 is attached to a position at which some of the letters 11C are formed among the letters 11C in the plurality of stages.

In the case of beverage products, for example, for the purpose of promotion, a campaign or the like where a purchaser of a beverage product can apply for and win various gifts is frequently performed, and, when the campaign as described above is to be performed, an application sticker (tack label) or the like as illustrated in FIG. 10A may be attached to the label, an outer surface of the container, or a cap, which needs efforts and costs in manufacturing.

Further, the tack label, such as an application sticker, is attached by a worker or by using a certain device, but it is difficult to attach the tack label at a predetermined position with accuracy. In addition, when the tack label has a polygonal shape, such as a star shape, or a shape of a certain character, and if the tack label is inclined in an arbitrary direction or misaligned, visual quality is reduced and a commercial value is reduced.

Furthermore, the tack label used as the application sticker is attached to the label or the outer surface of the container, so that the application sticker may be removed deliberately in a store or the like, or the tack label may be rubbed and removed accidentally depending on the way of handling at the time of product distribution.

In the present modification, the letters 11C including needed information, such as characters of “win” or information including a keyword, a code, or the like needed for application, are directly recorded on the container 1 instead of the application sticker, and the information is covered by the label 30 to hide the information during the product distribution.

A purchaser of the product is able to obtain the information recorded on the container 1 by removing the label 30; therefore, a problem with the tack label as described above does not occur and efforts and costs in manufacturing related to the tack seal are not needed.

Even if the tack label is attached to give a notice of a product campaign in a store, it is not necessary to write needed information on the tack label, so that it is possible to prevent the tack label from being removed deliberately.

As for the information to be written on the container, textual information, such as “win”, is satisfactory in the case of a campaign based on a scheme in which a gift is provided in a store in which the product is purchased, but, in the case of a campaign for which application through a communication means or the like is needed, it is sufficient to assign different kinds of information, such as a combination of a code as a combination of several alphabets and numerals and a keyword, to individual containers.

If an exhaustive state of the combinations of codes and keywords is extremely larger than a total production volume of a product, it is possible to perform screening with respect to false application. For example, if a six-letter code including alphabets and numerals is used, it is possible to generate the same number of codes as the sixth power of 36, that is, about 2200 million codes. It is sufficient to handle the sticker as an application sticker if an applied code matches the code that is written on the container at the time of production.

In the case of laser marking, it is possible to mark a different code onto each of containers at the time of producing the containers, without a need of a plate that is used for printing.

Furthermore, if a transparent beverage is contained in a transparent container, it may be possible to view information through the container and the beverage from a portion that is present on the opposite side of the position at which the information is written and that is not covered by the label, even without removing the label. In this case, because the color of the laser mark that is directly written on the container is white, it is possible to prevent the information from being viewed by realizing a cryptic color by coloring a base material of the label used as the cover in white or by printing a white label at the position at which the information is written.

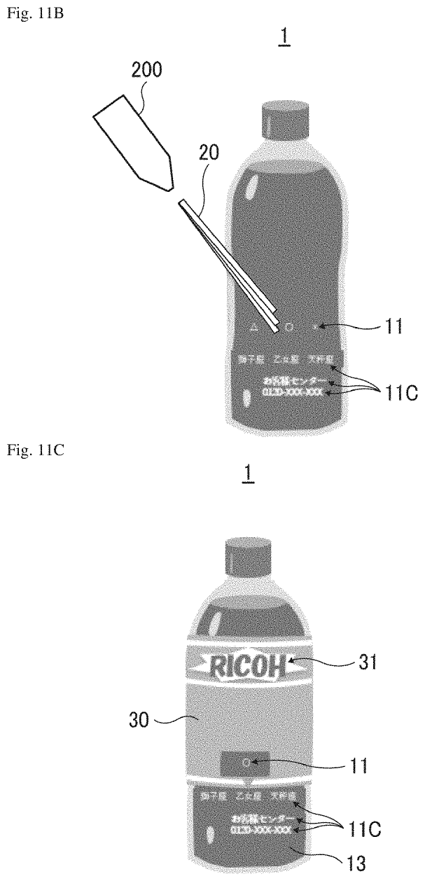

FIGS. 11A to 11C are diagrams for explaining a containing body according to a fourth modification of the present embodiment. FIG. 11A illustrates the label 30 according to the present modification, where the label 30 includes the window portion 32 in which the patterns 11 formed at the position at which the label 30 is attached are viewable.

FIG. 11B illustrates the containing body according to the present modification before the label 30 is attached, where the containing body includes the container 1 and the contents 1b. The letters 11C are formed in a plurality of stages on the base material 1a of the container 1. The letters 11C are one example of the patterns 11 in the plurality of stages that are formed by the machining laser beam 20 emitted by the laser irradiation unit 200. The patterns 11 formed of graphics are also formed at the position at which the label 30 is attached on the base material 1a of the container 1 illustrated in FIG. 11B.

FIG. 11C illustrates the containing body according to the present modification after the label 30 is attached, where the containing body includes the container 1, in which the label 30 is attached to the base material 1a, and the contents 1b.

The base material 1a of the container 1 includes the pattern region 13 including the letters 11C that are formed in the plurality of stages, and the label printing region 31 is formed on the label 30. The label 30 is attached to the position at which the patterns 11 formed of graphics are formed, but the patterns 11 are viewable from the window portion 32.

To increase sales of the product or perform a campaign of the product, in some cases, information that is unrelated to the product but that may attract attention of general consumers may be added to a package portion. Examples of the information include proverbs, sayings, meanings of four-character idioms, and tips and trivia about historic sites or world heritages. In particular, fortunes or fortune-telling corresponding to personal attributes, such as zodiac signs, blood types, gender, or hometowns, of purchasers attract attention of consumers.

In FIGS. 11A to 11C, a cut window or the window portion 32 including a transparent portion that transmits visible light is arranged in advance at a predetermined position on the printed label 30. On the container, for example, a combination of fortune-telling and 12 zodiac signs or the like are directly recorded at predetermined positions at predetermined intervals.

By attaching the label to the portion in which the marking is directly performed on the container, it is possible to add a new value to the container 1. In other words, by rotating and locating the window of the label or the transparent portion (or an inverted-triangle mark) in the circumferential direction of the container in accordance with a desired zodiac sign that is directly written on the container, it is possible to obtain information on a fortune-telling for a desired zodiac sign of a purchaser.

This information can achieve the same effect even with use of a classification of blood types, hometowns, ages, or other attributes rather than the zodiac signs, and information corresponding to the classification.

The PET container is reused mainly by efforts of individual consumers rather than efforts of manufacturers, and, various uses of the container, such as a use as a case in home or a use as an accessary case, by taking advantage of lightness in weight and robustness are introduced by the Internet and books.

However, if the container is reused as a case, for example, because a dedicated case provided as a product has useful functions, the reused case has a negative aspect in terms of usability, although the reused case has positive effects such that it is not necessary to pay for it and it is possible to contribute to reduction in environmental burdens.

By setting, in the container, a function to improve usability at the time of reuse of the container, a product manufacture can appeal environmental consideration and environment-friendly actions, and a user is able to eliminate the negative aspect of the reuse of the container and promote the reuse.

As a method of reusing the PET container, a method of reusing the container as a case for storing grain, such as rice, is widely known. If a scale, such as sho, go, little (L), or deciliter (dl), which is used to measure the amount of rice is directly recorded in advance on the container by laser marking, it is possible to set a function to easily recognize an indicator for measurement or residual amount, so that it is possible to improve usability at the time of reuse as the case.

Furthermore, it may be possible to cover, by the label, the scale that is directly recorded on the container when the container is distributed as a product. By implementing the function by removing the label after purchase and use, it is possible to maintain beauty and visual integrity as a product that appeals to consumers and set the usability at the time of reuse.

Moreover, as another method of reusing the PET container, it is known that the container may be used as a case, such as a penholder, by cutting the container using a tool, such as a cutter, or the container may be used as a tool or a toy, such as a windmill, by cutting the container and punching holes. By directly recording a cut line in advance on the container by laser marking, it is possible to improve usability at the time of reuse.

Even in this case, it is possible to cover, by the label, the cut line that is directly recorded on the container when the container is distributed as a product.

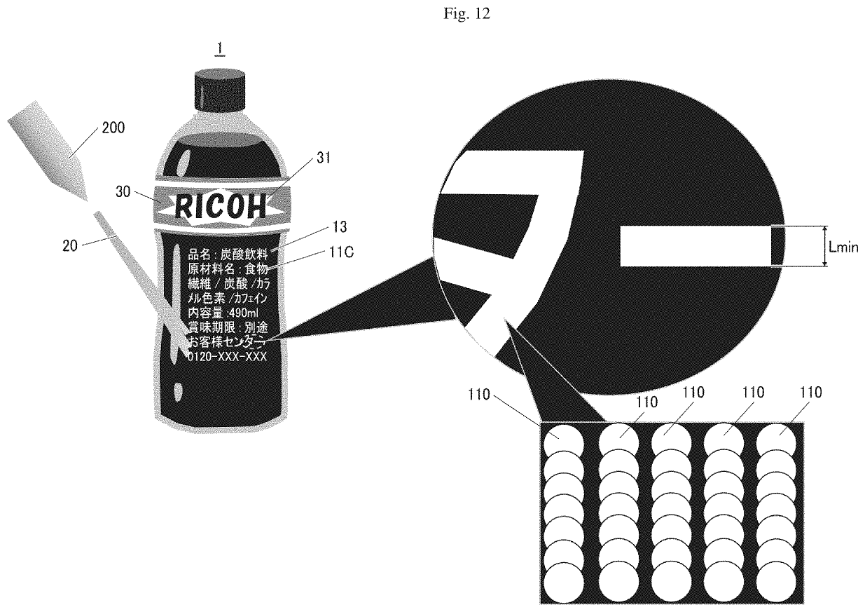

FIG. 12 is a diagram for explaining the patterns on the containing body according to the present embodiment. In the container 1 illustrated in FIG. 12, a minimum width Lmin of a thinnest portion of the letters 11C is equal to or smaller than 300 um, and is formed by arranging the dots 110, which are one example of second patterns, in an overlapping manner.

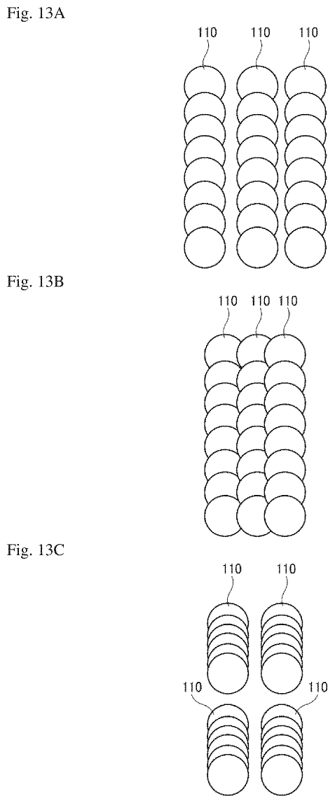

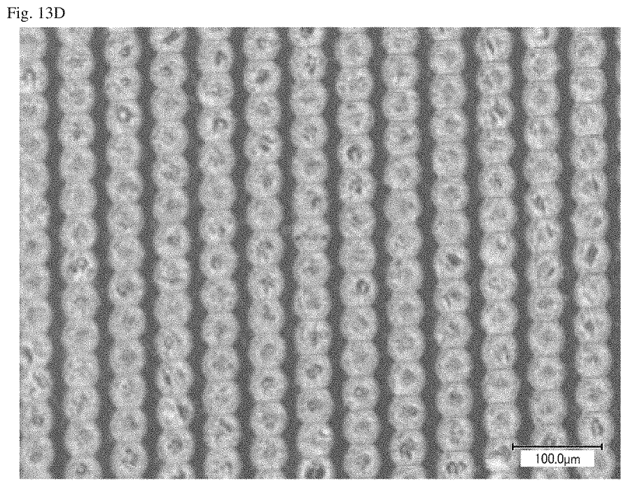

FIGS. 13A to 13D are diagrams for explaining the patterns according to the present embodiment. As illustrated in FIGS. 13A to 13D, the first pattern may be formed by forming the second patterns, which are minute patterns, in a partially overlapping and continuous manner or in a partially overlapping and non-continuous manner. Specifically, the first pattern is formed by arranging the dots 110 that are one example of the second patterns in an overlapping manner as illustrated in FIG. 13A, by arranging the dots 110 in an overlapping manner in both of a main laser scanning direction and a sub laser scanning direction as illustrated in FIG. 13B, or by partially increasing an overlapping ratio of the dots 110 and arranging oval-shaped dots as illustrated in FIG. 13C.

With this configuration, even if the degree of optical diffusion of each of the second patterns is small, because the number of aggregations of the second patterns is large, the optical diffusion of the generated pattern 1 is increased, so that the pattern can be viewed at high contrast in a good manner.

FIG. 13D illustrates a pattern that is actually formed on a transparent base. As an example of a formation condition, circular patterns as the second patterns each having an outer diameter of about 40 um are continuously formed at the same pitches as the outer diameter size of 40 um or larger. By forming the second patterns in an overlapping manner as described above, edges on lines are not straight lines, but have shapes that are formed such that arcs that are partially cut portions of non-overlapping portions are continued. In this state, optical diffusion performance increases as compared to a straight line state, so that the optical diffusion is further improved and the dots can be viewed at high contrast in a good manner.

Meanwhile, a feature of the present embodiment is to locally apply laser light to form a pattern by using a morphological change in an irradiated minute region. Therefore, the way of morphological change is not specifically limited. For example, if laser light is locally applied, gas bubbles are generated inside the base material due to thermal effect, air bubbles that are gasified and evaporated are contained in the vicinity of a surface layer of the base material, and whitish bumps are resultantly generated, which may serve as the second patterns.

Furthermore, in some cases, the second patterns may be formed in such a manner that laser energy is absorbed and then molecular density is increased and condensation occurs due to thermal effect.

Moreover, if the base material contains a pigment or the like, the second patterns include those that are colored with an increase in concentration of the pigment or the like because of a chemical change in component compositions due to a change in a molecular structure or a change in a hydration amount in a crystal caused by laser irradiation.

Thus, each of the second patterns as described above can be formed by locally applying energy. In other words, machining using pulse driving is preferable, and the second patterns can be formed by using any of a femtosecond pulsed laser, a nanosecond pulsed laser, and a picosecond pulsed laser.

In this manner, according to the present invention, with use of a pulsed laser in particular, it is possible to locally form the dot portions, so that it is possible to write a line with a width of 300 um or less, which is not writable using conventional CO2 laser or the like.

As compared to the femtosecond pulse laser, the nanosecond pulse laser, and the picosecond pulse laser, a laser, such as a CO2 laser, for which a wavelength of a laser light source is large has a large beam spot diameter, so that a machining width on a container main body increases. As a result, a minimum width of a thinnest portion in a pattern, such as a letter, formed by laser irradiation is still larger than those formed with the femtosecond pulse laser, the nanosecond pulse laser, or the picosecond pulse laser. It is general to form a letter unicursally in marking using a CO2 laser; however, in this case, a minimum width is a line width of the letter.

Conclusion

As described above, the container 1 according to one embodiment of the present invention is the container 1 in which the label 30 is attached to the base material 1a, and the patterns 11 are formed in a plurality of stages on the base material 1a by performing laser irradiation. With this configuration, it is possible to provide the container 1 that takes advantage of both of the label 30 and the patterns formed by the laser irradiation.

The patterns 11 are formed of an aggregation of the dots 110. With this configuration, it is possible to easily form the patterns with good visibility.

The pattern region 13 in which information, such as a numeral, a symbol, or an image, is made visible by the patterns 11, and the label printing region 31 which is formed on the label 30 and in which information, such as a numeral, a symbol, or an image, is made visible are included. The pattern region 13 is one example of the first information region, and the label printing region 31 is one example of the second information region.

With this configuration, it is possible to provide the container 1 that includes the pattern region 13 including information, such as laws, standards of industrial organizations, and standards of manufacturers, which is written for the purpose of consumer protection, environment conservation, social responsibility, production management, and product distribution, and the label printing region 31 including relatively large characters or graphics, such as a manufacturer name, a product name, a logo, a feature of a product, and an effect of the product, with visibility that allows the product to appeal customers or allows the customers to recognize the product.

A smallest width of a thinnest portion of the patterns 11 formed by the laser irradiation is equal to or smaller than 300 um.

The patterns 11 are formed at positions different from a position at which the label 30 is attached. With this configuration, the patterns 11 and the label 30 can display information at different positions.

The label 30 is attached to a position at which the patterns 11 are formed. In this case, a frictional force is increased by the patterns 11, so that the attachment performance of the label 30 increases. Furthermore, it is possible to confirm information represented by the patterns 11 by removing the label 30.

The label 30 includes the window portion 32 in which the patterns 11 formed at the position at which the label 30 is attached is viewable. In this case, it is possible to view the patterns 11 formed at the position at which the label 30 is attached, without removing the label 30.

Acording to an embodiment, it is possible to provide a container that takes advantage of both of a label and a pattern.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

### REFERENCE SIGNS LIST

1 container

1a base material

1b contents

10 cylindrical axis

11 pattern

11C letter

110 dot portion (one example of predetermined shape or dot)

111 recess (one example of predetermined recess)

1111 first inclined surface

1112 bottom portion

112 protrusion (one example of predetermined protrusion)

1121 apex portion

1122 second inclined surface

113 asperity portion

12 non-pattern region (one example of second region)

13 pattern region (one example of first information region)

100 manufacturing apparatus

200 laser irradiation unit

20 machining laser beam

21 laser light source

22 beam expander

23 scanning unit

24 scanning lens

25 synchronous detection unit

3 rotation mechanism

4 moving mechanism

5 dust collection unit

6 control unit

30 label

31 label printing region (one example of second information region)

32 window portion

33 seal portion

34 perforation

A region

B perspective view

dp depth

Dc recess width

Dr torus width

h height

W dot width

What is claimed is:

1. A container in which a label is attached to a base material, the container comprising:
patterns formed in a plurality of stages on the base material by laser irradiation.

2. The container according to claim 1, wherein the patterns comprise an aggregation of dots formed by the laser irradiation.

3. The container according to claim 1, further comprising:
a first information region in which information including a numeral, a symbol, or an image is made visible by the patterns; and
a second information region which is formed on the label and in which information including a numeral, a symbol, or an image is made visible.

4. The container according to claim 1, wherein a minimum width of a thinnest portion of the patterns formed by the laser irradiation is equal to or smaller than 300 um.

5. The container according to claim 1, wherein the patterns are formed at positions different from a position at which the label is attached.

6. The container according to claim 1, wherein the label is attached to a position at which the patterns are formed.

7. The container according to claim 6, wherein the label includes a window portion in which the patterns formed at the position at which the label is attached are viewable.

8. A containing body comprising:
the container according to claim 1; and
contents contained in the container.
